(19) United States
(12) Patent Application Publication
(10) Pub. No.: US 2012/0253905 A1
(43) Pub. Date: Oct. 4, 2012

(54) SYSTEM AND METHOD OF PROMOTING A SALE OF RETAIL GOODS

(75) Inventor: Sean De Jesus Darragh, Sandy, UT (US)

(73) Assignee: Mr. Sean De Jesus Darragh, Sandy, UT (US)

(21) Appl. No.: 13/435,232

(22) Filed: Mar. 30, 2012

Related U.S. Application Data
(60) Provisional application No. 61/470,075, filed on Mar. 31, 2011.

(51) Int. Cl. G06Q 30/02; G06Q 30/06

(52) U.S. Cl. 705/14.19

(57) ABSTRACT

There is a system and method for promoting the sale of retail goods over a computerized network. The system and method includes a virtual shopping cart module operationally deliverable to a mobile communication device over a network. The virtual shopping cart module includes a reader module configured to scan a physical tag of a retail item. The virtual shopping cart module includes a purchase module configured to facilitate purchase of items associated with the virtual shopping cart data. The cart module includes a review module configured to query a consumer regarding an opportunity to purchase a retail item associated with virtual shopping cart data. The virtual shopping cart module includes an incentive module and a rewards module configured to manage rewards and incentives of a consumer associated with the virtual shopping cart data.

### CROSS-REFERENCE TO RELATED APPLICATIONS

This invention claims priority, under 35 U.S.C. §120, to the U.S. Provisional Patent Application No. 61/470,075 to Sean De Jesus Darragh filed on Mar. 31, 2011, which is incorporated by reference herein in its entirety.

### BACKGROUND OF THE INVENTION

1. Field of the Invention

The present invention relates to retail systems and methods, specifically to a system and method of promoting a sale of retail goods.

2. Description of the Related Art

Promotional marketing includes a promotional mix or a promotional plan. These elements might include personal selling, advertising, sales promotion, direct marketing, and publicity. A promotional mix specifies how much attention should be paid to each of the five subcategories, and how much money to budget for each. A promotional plan can have a wide range of objectives, including: sales increases, new product acceptance, creation of brand equity, positioning, competitive retaliations, or creation of a corporate image. Fundamentally, however there are three basic objectives of promotion. These are to present information to consumers as well as others, to increase demand, and to differentiate a product.

There are different ways to promote a product in different areas of media. Promoters use internet advertisement, special events, endorsements, and newspapers to advertise their product. Many times with the purchase of a product there is an incentive like discounts, free items, or a contest. The term “promotion” is usually an “in” expression used internally by the marketing company, but not normally to the public or the market—phrases like “special offer” are more common. However, it is sometimes difficult to understand or even gather relative information that include a direct correlation or reasoning as to why a consumer did or did not make a purchase while visiting a retail store or online retail website.

Some improvements have been made in the field. Examples of references related to the present invention are described below in their own words, and the supporting teachings of each reference are incorporated by reference herein:

U.S. Patent Application Publication No.: 2010/0070357, by Fenton, discloses a method and system for providing an incentive for social network members (SNMs) to opt into a promotional program associated with a seller of goods or services. The SNMs may be provided an initial incentive to opt into a promotional program associated with a seller of goods or services and responsive to an SNM electronically opting in to the promotional program, the SNM may be provided with an additional incentive to identify additional SNMs as opt in candidates. Store coupons or product coupons may be utilized to provide the incentive. The additional incentive may include increasing the value of the initial incentive. The initial incentive may only be available for a predetermined period of time. The additional SNMs may be provided with an incentive to identify yet additional SNMs as opt in candidates.

U.S. Patent Application Publication No.: 2006/0074769, by Looney et al., discloses a personalized marketing architecture use real-time data and explicit customer input to augment marketing segmentation, analysis and video advertisement delivery. Customer behavior, preferences, and intentions are monitored and identified to present real-time video messages. Real-time data may be collected based on the customer's data access permission profile to provide messages on an in-home personal portal or on out-of-home display devices to provide personalized messages in public spaces.

U.S. Patent Application Publication No.: 2006/0143091, by Yuan et al., discloses a shopping assistant method and system provides a consumer with a mobile terminal in a shopping mall as a shopping assistant. The consumer can input a shopping list to the mobile terminal in advance and login at an entrance of the shopping mall in a wireless way for sending the shopping list to a remote server in the shopping mall. The remote server finds goods in the shopping list from its database that have identical names and other goods having information that meets with a pre-stored preference condition, and then sends the information found to the mobile terminal for display. Accordingly, the consumer can conveniently compare prices among numerous goods and quickly get the desired goods, or the closest ones. When the consumer finishes shopping, the remote server further deducts the amount from a personal financial account so as to complete an e-commerce.

U.S. Patent Application Publication No.: 2002/0072974, by Pugliese et al., discloses a ShopLive system supports existing merchants and malls to better serve customers by providing easy access to merchandise and sales assistants over a communication network to display items and to provide expert information on products. The shopping experience is enhanced by tokens to allow ease of shopping and checkout. Items purchased that need installation or service or supported by accessing live experts. Direct connection to service providers is available over the network. If a shopper does not find the desired merchandise they are referred to another merchant who has the product and the referring merchants receives a commission or other consideration.

U.S. Patent Application Publication No.: 2002/0059198, by Yamashita et al., discloses a problem of the present invention is to provide a retrieval method and system for casting information in order to provide material for estimation of the origin of a defect of a casting. The present invention comprises a computer system 1 comprising the following: a database 2 capable of classification of each datum according to a for-reference-use keyword and comprising data groups integrated together with corresponding for-reference-use keywords and data obtained by previous inspection-analysis; an input unit 3 for input of a for-retrieval-use keyword relating to the casting in which the defect occurs; a CPU 4 for retrieval from the database of a for-reference-use keyword corresponding to the for-retrieval-use keyword sent from input unit 3, and for extraction from the database of a datum relating to casting information containing the retrieved for-reference-use keyword; and an output unit 5 for output of casting information based upon data sent from CPU 4.

The inventions heretofore known suffer from a number of disadvantages which include being limited in use, being difficult to use, being difficult to analyze, being complex, being limited in application, being limited in relative consumer data or feedback, being expensive, being inefficient, being ineffective, being difficult to manage, failing to provide certain information to retailers, failing to provide certain information to brick-and-mortar retailers, and failing to re-engage shoppers and/or failing to provide opportunities and/or incentives for shoppers to purchase previously discarded items.

What is needed is a system and method of promoting a sale of retail goods that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods of promotional marketing and analysis. Accordingly, the present invention has been developed to provide a system and method of providing effective and efficient promotion of a sale of retail goods.

According to one embodiment of the invention, there is a method of promoting a sale of retail goods. The method may include the step of providing a virtual shopping cart module to a mobile device of a prospective customer. The method may include reading identification data of a physical item of interest to the prospective customer at a retail store through operation of a reader module of the virtual shopping cart module. The method may include the step of querying the prospective customer in regards to the physical item of interest. The step may also include storing an answer from the prospective customer and associating the answer with the identification data of the physical item of interest.

The method of promoting a sale of retail goods may include providing a reward to the prospective customer. The step of providing a reward to the prospective customer may include awarding virtual points associated with a user profile of the prospective customer in response to receiving an answer. The method may include the step of providing a first purchase opportunity for the prospective customer to purchase the physical item of interest. The first purchase opportunity may include a purchase incentive. The method may include determining whether the prospective customer purchases the physical item of interest during the first purchase opportunity and providing a second purchase opportunity if the prospective customer did not purchase the physical item of interest during the first purchase opportunity. The second purchase opportunity may include an enhanced incentive to purchase the physical item of interest. The method may further include the step of communicating identification data of a physical item of interest to a server module over a network.

The method of promoting a sale of retail goods may include the step of querying the prospective customer as to a purchase decision associated with the first purchase opportunity. The method may include the step of communicating purchase decision information to a server module over a network. The method may also include automatically generating a purchase incentive based on user profile information. The method may include the step of automatically generating an enhanced purchase incentive based on purchase decision information. The method may further include the step of communicating an enhanced purchase incentive from a server module to a mobile device over a network.

According to one embodiment of the invention, there is a system for promoting the sale of retail goods over a computerized network. The system may include a virtual shopping cart module that may be operationally deliverable to a mobile communication device over a network. The virtual shopping cart module may include a reader module that may be configured to scan a physical tag of a retail item. The reader module may include instructions for controlling a sensing device of a mobile communications device configured to sense identifying information from a physical tag. The cart module may include a storage module that may be in communication with the reader module and may be configured to store scanned data as a virtual shopping cart, wherein scanned items may be queued for purchase.

The virtual shopping cart module may include a purchase module that may be in communication with the storage module and may be configured to facilitate purchase of items associated with the virtual shopping cart data. The purchase module may include instructions for assigning a characteristic of abandoned to a virtual shopping cart data set in response to failure to purchase a scanned item within a predetermined purchase characteristic, thereby forming an abandoned virtual shopping cart. The cart module may include a review module that may be configured to query a consumer regarding an opportunity to purchase a retail item associated with virtual shopping cart data.

The virtual shopping cart module may include an incentive module that may be configured to provide incentives to a consumer for reviewing a retail item associated with virtual shopping cart data. The cart module may also include a rewards module that may be configured to manage rewards and incentives of a consumer associated with the virtual shopping cart data. The rewards module may include instructions for providing a reward for purchasing an item of an abandoned virtual shopping cart. The cart module may further include a global positioning module that may be configured to track consumer global positioning.

The system may include a merchant module that may be in communication with the virtual shopping cart module over a network. The merchant module may include an administration module that may be configured to provide operational instructions to manage the modules and components of the merchant module. The merchant module may include a communication module that may be in communication with the administration module and may be configured to provide communication to the modules and components of the merchant module. The merchant module may include a storage module that may be in communication with the administration module and may be configured to store merchant and consumer data.

The merchant module may include a query module that may be in communication with the storage module and may be configured to query a consumer regarding a purchase or non-purchase of a retail item. The merchant module may include an incentive offer module that may be in communication with the query module and may be configured to provide an incentive to a non-purchasing consumer. The merchant module may also include a reward generating module that may be in communication with the query module and may be configured to provide a reward for a consumer completing a query.

The merchant module may include a tracking module that may be in communication with the administration module and may be configured to track global positioning data from the global positioning module of the consumer module. The merchant module may include an analysis module that may be in communication with the query module and the storage module, and may be configured to analyze data from the consumer module.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a system and method of promoting a sale of retail goods, according to one embodiment of the invention;

FIG. 2 illustrates a virtual shopping cart module of a system of promoting a sale of retail goods, according to one embodiment of the invention;

FIG. 3 illustrates a merchant module of a system of promoting a sale of retail goods, according to one embodiment of the invention;

FIG. 4 illustrates a method of promoting a sale of retail goods, according to one embodiment of the invention;

FIG. 5 illustrates a method of promoting a sale of retail goods, according to one embodiment of the invention; and

FIG. 6 illustrates a personal digital assistant including a virtual shopping cart module of a system of promoting a sale of retail goods, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other. Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

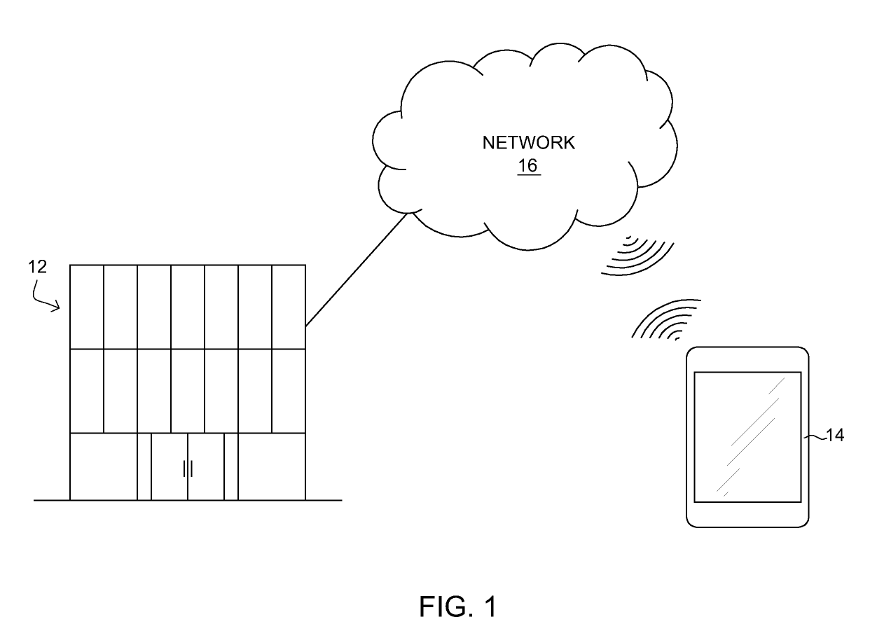

FIG. 1 illustrates a network diagram of a system and method of promoting a sale of retail goods, according to one embodiment of the invention. There is shown a retail shopping store 12 in communication with a personal digital assistant 14 over a network 16. The illustrated retainer shopping store 12 includes a physical location from which goods/services are sold to those present within the store and also includes one or more computing devices, modules and/or computing systems sufficient to perform the operations described herein that may be in communication with each other to a degree useful in performing such functions. Non-limiting examples of the same are cash registers, POS software systems, network communications devices, servers, wired networks, wireless networks, scanners, sensors and the like and combinations thereof.

The illustrated retail shopping store 12 is configured to be in communication with a network 16. The retail shopping store 12 is configured to provide inventory data, purchase data, and store data over the network 16 to be accessible to a plurality of viewers/consumers. Such a store may include one or more computers, computing devices, servers, and the like and combinations thereof which may also include one or more communications modules such as but not limited to network cards, wireless routers, cell-phone transponders, and the like and combinations thereof. The plurality of viewers/consumers may access the data from the retail shopping store 12 with a personal digital assistant or a mobile communication device 14 such as but not limited to a smart phone, cell phone, PDA, tablet PC, handheld computing device, smart media player, and the like and combinations thereof. The illustrated mobile communication device 14 is configured to access and navigate a retail shopping store website or web portal and view the data therethrough.

The retail shopping store 12 is configured to detect when a mobile communication device 14 is within a vicinity of the retail shopping store 12. Such may occur through a variety of methods, including but not limited to location detection by the mobile device 14 itself determining it is located within the store and then sending a signal over the network to announce its presence, the store passively detecting a signal emitted by the mobile communications device while present within the store, the user of the mobile communications device registering with a computing device of the store on entry or during the stay, or the like and combinations thereof. The illustrated retail shopping store 12 is configured to detect when a mobile communication device 14 is within the retail shopping store 12.

The illustrated mobile communication device 14 is configured to receive data regarding retail goods available at the retail shopping store 12. Such may occur by direct download of a portfolio of goods, by the user scanning goods with the mobile device, by proximity detection (through the mobile device and/or through one or more devices in the store) in combination with a map of goods locations within the store, and the like and combinations thereof. Through one or more selection methods, the system determines that one or more goods/services provided by the retail store have been observed, examined, noticed, selected, chosen, or otherwise made special in association with the carrier of the mobile communications device in contrast to other items within the store. These items that are dubbed “special” or otherwise mark as being of interest may be considered to be within a virtual shopping cart of the carrier of the mobile communications device. The purchase of such items is of benefit to the retail store, but the non-purchase of such items generally goes completely unnoticed and unassociated with the associated consumer. In the presently described embodiment, such is no longer the case. In particular, once an item has been declared “special” to an associated consumer and has not been associated with a transaction by that same consumer, the system may employ methods described herein to attempt to sway the consumer to complete a purchase. Advantageously, a retail store may then increase sales and drive additional traffic through its stores. Further, such a system may gather critical purchasing/non-purchasing information from its consumers for use by the retail store, the system described herein, and even manufacturers of items.

In particular, the illustrated mobile communication device 14 is also configured to receive purchasing questions from the retail shopping store 12. Non-limiting examples of purchasing questions that the retail shopping store 12 may ask the viewer/consumer of the mobile communication device 14, may be: “Would you like to purchase this item?”; “Why did you not purchase this item?”; “Why did you purchase this item?”; “Please rate the following item”; “Would you purchase this if it was discounted by 15%?”; and etc. and the like and combinations thereof. Such questions may be triggered dependent on one or more factors, including but not limited to answers to previous questions; an amount of passage of time between purchases, non-purchases, product viewings, store visits and the like and combinations thereof; the success/failure rate of such and/or similar questions in securing desired behavior such as but not limited to inducing and/or influencing additional store visits, purchases, item reviews, answers to questions asked and the like and combinations thereof; previous offers made; potential offers to be made; random selection; split-testing processes; and the like and combinations thereof.

The retail shopping store 12 is configured to generate a reward or an incentive to the viewer/consumer that completes the purchasing questions. The reward or incentive may be related to the retail item in question or may be any type of discount or reward redeemable at the retail shopping store 12, such as but not limited to discounts, rebates, free items, cash, cash equivalents, “points” like airplane miles or loyalty points, free/discounted services, access to exclusive content, access to exclusive memberships, data of value, and the like and combinations thereof. The retail shopping store 12 is configured to store viewer/consumer data such as within a database. Such data may include but is not limited to demographic information about the consumer/account, historical data about activities associated with the account, offers received by the account, offers accepted by the account, purchases made by the account, purchases abandoned by the account, and the like and combinations thereof. The retail shopping store 12 may be configured to query such a database to generate marketing strategies or trends of the viewers/consumers visiting the retail shopping store 12.

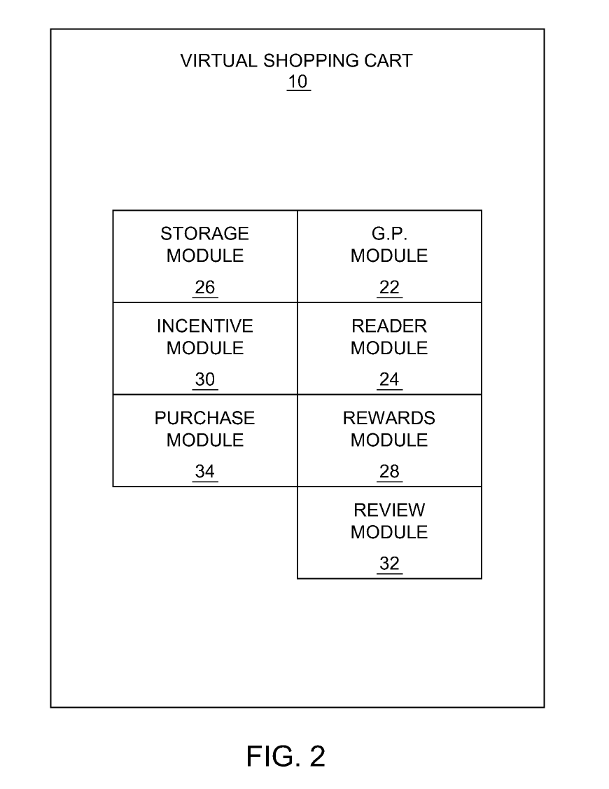

FIG. 2 illustrates a virtual shopping cart module of a system of promoting a sale of retail goods, according to one embodiment of the invention. There is shown a virtual shopping cart module 10 including a global positioning module 22, a reader module 24, a storage module 26, a rewards module 28, an incentive module 30, a review module 32, and a purchase module 34. The illustrated modules may be in communication one with another in combinations of and to the degree necessary to perform the functions described herein. Such may include one-way or two way data communications over a bus, network, or similar structure. Such may also be indirect communications as one or more modules (described herein or otherwise) may serve as intermediaries between modules where data may be usefully passed.

The illustrated virtual shopping cart module 10 is configured to be viewed, navigated, and operated through a mobile communication device over a network. The virtual shopping cart module 10 is configured to be in communication with a retail shopping store over a network. The virtual shopping cart module 10 is activated upon entering a retail shopping store, and configured to provide purchasing, reviewing, and searching retail item capabilities to a viewer/consumer while shopping at the retail shopping store. As one non-limiting example, such a shopping cart module (or any of the other modules described herein) may be embodied, partially or fully, as a downloadable application for a smartphone such as but not limited to an iPhone by Apple Computers or a Droid by Motorola. As another non-limiting example, such a shopping cart module (or any of the other modules described herein) may be embodied, partially or fully, as a website accessible by a mobile communications device.

The illustrated virtual shopping cart module 10 includes a reader module 24 configured to scan a physical tag of a retail item within a retail shopping store or otherwise select one or more goods/services proximate the user as being “special.” The reader module 24 may include instructions for a sensing device of a mobile communication device configured to sense identifying information from a physical tag. The sensing device may be a camera of a mobile communication device configured to scan/read a RFID tag of a retail item. The reader module 24 is configured retrieve retail item data from a retail shopping store database and present it to the viewer/consumer. The reader module 24 is configured to scan a plurality of various types of bar codes configured to track inventory, such as but not limited to: RFID tags, QR barcodes, linear barcodes, Matrix 1D or 2D barcodes, etc. and still perform its intended function. Non-limiting examples of a reader module may be a cellular camera phone as described in U.S. Patent Publication No.: 2011/0212751, by Havens et al.; or a directional RFID reader as described in U.S. Patent Publication No.: 2009/0295541, by Roof, wherein these examples are incorporated for their supported teachings herein.

The illustrated virtual shopping cart module 10 includes a storage module 26 in communication with the reader module 24. The storage module 26 is configured to store scanned data, such as RFID tags from retail goods available at a retail shopping store, as a virtual shopping cart. The scanned items are queued for purchase and ready for checkout. The storage module 26 is also configured to store retail item data from previous visits to the retail shopping store. Non-limiting examples of data storage modules includes databases and/or data files. Non-limiting examples of hardware associated with and/or incorporated in such modules includes hard drives, flash drives, magnetic discs, optical discs, and/or tapes and the like and combinations thereof. Non-limiting examples of a storage module may be a portable data storage module as described in U.S. Pat. No. 7,802,729, issued to Thayer; or a data storage system described in U.S. Pat. No. 8,006,012, issued to Hou et al.; wherein these examples are incorporated for their supported teachings herein.

The illustrated virtual shopping cart module 10 includes a purchase module 34 in communication with the storage module 26 and configured to facilitate purchase of items associated with the virtual shopping cart data. The purchase module 34 includes instructions for assigning a characteristic of abandoned to a virtual shopping cart data set in response to failure to purchase a scanned item within a predetermined purchase characteristic, thereby forming an abandoned virtual shopping cart. Such may also include instructions for communication with one or more purchasing systems of the retailer in order to identify which items have been purchased by the carrier of the mobile device, including but not limited to POS systems, inventory systems, customer service systems, customer account tracking systems, buyer reward systems, and the like and combinations thereof. Such systems may provide real-time information about purchases and non-purchases or may update on particular occasions. As a non-limiting example, a system may update on exit from a retail store associated with the system such that the items within the virtual shopping cart may be matched against purchase data polled from the retail store system to determine what was purchased during that shopping event and what was abandoned. The purchase module 34 is configured to store purchasing data associated with the viewer/consumer. Non-limiting examples of a purchase module may be a purchase module as described in U.S. Patent Publication No.: 2010/0179846, by Best et al.; or a purchase module as described in U.S. Patent Publication No.: 2010/0094726, by Tuli; wherein these examples are incorporated for their supported teachings herein.

The virtual shopping cart module 10 includes a review module 32 configured to query a consumer regarding an opportunity to purchase a retail item, from a retail shopping store, associated with virtual shopping cart data. The review module 32 is configured to query a consumer a set of purchasing questions; in particular purchasing questions as to why or why not the consumer purchased or did not purchase a retail item associated with the virtual shopping cart data. The review module 32 is in communication with the retail shopping store; wherein the retail shopping store is configured to query and analyze query answers from the consumer to assist in generating future marketing strategies. Queries may be scheduled according to a script/schedule and/or may be selected by an intelligent system configured to optimize one or more of data collected, responses, useful responses, future purchases, and the like and combinations thereof. Factors that may be analyzed by such an intelligent system may include but are not limited to historical purchase data, demographic data of the account holder, current sales trend data, location data (like GPS data), future release data from manufacturers/providers, pricing data, inventory level data, and the like and combinations thereof. Answers from consumers may be in the form of free text, multiple choice, alternative selection, passive consent to particular answers, or the like or combinations thereof and the review module may include instructions for receiving such answers in on or more varied forms. Non-limiting examples of a review module may be a query engine as described in U.S. Pat. No. 6,641,037, issued to Williams; or a product query described in U.S. Patent Publication No.: 2007/0011055, by Ruul; or a query module as described in U.S. Pat. No. 7,860,886, issued to Loftesness; wherein there examples are incorporated for their supported teachings herein.

The virtual shopping cart module 10 includes an incentive module 30 configured to provide incentives to a consumer for reviewing and answering queries related to a retail item associated with virtual shopping cart data. The incentive module 30 is configured to provide an incentive to a consumer for completing a task at a retail shopping store. The task may be reviewing a retail item, rating a retail item, answering queries related to retail items, answering purchasing queries related to the consumer's current or past experiences at the retail shopping store, or purchasing a retail item. The incentive may include a discount for purchasing a retail item associated with the virtual shopping cart data, during a predetermined amount of time set by the retail shopping store. Incentives may be scheduled according to a script/schedule and/or may be selected by an intelligent system configured to optimize one or more of data collected, responses, useful responses, future purchases, and the like and combinations thereof. Factors that may be analyzed by such an intelligent system may include but are not limited to historical purchase data, demographic data of the account holder, current sales trend data, location data (like GPS data), future release data from manufacturers/providers, pricing data, inventory level data, and the like and combinations thereof. Non-limiting examples of an incentive module may be a method and apparatus for rewarding a customer referral as described in U.S. Patent Publication No.: 2006/0229936, by Cahill; or a method and system for offering purchase incentives as described in U.S. Patent Publication No.: 2010/0010888, by Maertz; or a system and method for providing incentives to purchase as described in U.S. Patent Publication No.: 2010/0153198, by Murphy et al.; wherein these examples are incorporated for their supported teachings.

The virtual shopping cart module 10 includes a rewards module 28 configured to manage rewards and incentives of a consumer associated with the virtual shopping cart data. The rewards module 28 includes instructions for providing a reward for purchasing an item of an abandoned virtual shopping cart. The rewards module 28 is in communication with the review module 32 and may be configured to provide a reward to a consumer for answering queries by the review module 32. The consumer may also receive a reward for performing activities within the retail shopping store, such as scanning a retail item, rating a retail item, reviewing a retail item, reviewing experience at the retail shopping store, etc. Rewards may be scheduled according to a script/schedule and/or may be selected by an intelligent system configured to optimize one or more of data collected, responses, useful responses, future purchases, and the like and combinations thereof. Factors that may be analyzed by such an intelligent system may include but are not limited to historical purchase data, demographic data of the account holder, current sales trend data, location data (like GPS data), future release data from manufacturers/providers, pricing data, inventory level data, and the like and combinations thereof. Non-limiting examples of a reward module may be a system and method for granting promotional rewards to credit account holders as described in U.S. Patent Publication No.: 2011/0022448, by Strock et al.; or a rewards system as described in U.S. Patent Publication No.: 2006/0287871, by Carrozzi et al.; wherein these examples are incorporated for their supported teachings herein.

The virtual shopping cart module 10 also includes a global positioning module 22 configured to track consumer global positioning relative to a retail shopping store. The global positioning module 22 is configured to track the movement of the consumer while shopping at the retail shopping store. The global positioning module 22 is in communication with the storage module and is configured to track global positioning data therein. The global positioning module 22 may be configured to activate the virtual shopping cart module 10 once, the consumer has entered the retail shopping store or a vicinity thereto. Non-limiting examples of global positioning modules include: a global positioning system described in U.S. Pat. No. 6,002,363, issued to Krasner, which is incorporated for their supported teachings herein; a Garmin e Trex Hiking GPS receiver, manufactured by Garmin International, Inc., 1200 East 151^{st} Street, Olathe, Kans., 66062, USA.

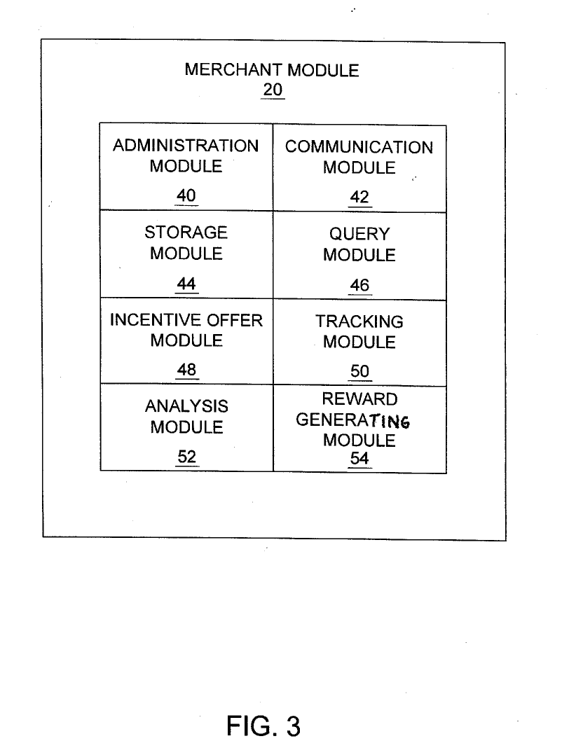

FIG. 3 illustrates a merchant module of a system of promoting a sale of retail goods, according to one embodiment of the invention. There is shown a merchant module 20 including an administration module 40, a communication module 42, a storage module 44, a query module 46, an incentive offer module 48, a tracking module 50, and an analysis module 52. The illustrated modules may be in communication one with another in combinations of and to the degree necessary to perform the functions described herein. Such may include one-way or two way data communications over a bus, network, or similar structure. Such may also be indirect communications as one or more modules (described herein or otherwise) may serve as intermediaries between modules where data may be usefully passed.

The illustrated merchant module 20 is configured to manage the data and content sent to and received from a virtual shopping cart module over a network. The merchant module 20 is in communication with a retail shopping store and a personal communication device; wherein the merchant module sends and receives data therefrom. The merchant module 20 includes an administration module 40 in communication with a central database associated with a retail shopping store and configured to provide administrative capabilities and operational instructions to the manage the modules and components of the merchant module 20.

The illustrated administration module 40 is configured to provide preset time periods for the expiration of rewards and incentives given to consumers for completing a task with the virtual shopping cart module at a retail shopping store. The administration module 40 is configured to track revenue generated from the use of rewards and incentives through the virtual shopping cart module at a retail shopping store. The administration module 40 is configured to provide an interface to navigate and manage the modules and components of the merchant module 20. Non-limiting examples of an administration module 40 may be an administration module as described in U.S. Patent Publication No.: 2010/0242051, by Roettger et al.; or an administration module as described in U.S. Pat. No. 7,275,098, issued to Becher et al.; wherein these examples are incorporated for their supported teachings herein.

The merchant module 20 includes a communication module 42 in communication with the administration module 40 and configured to provide communication capabilities to the modules and components of the merchant module 20. The communication module 42 is in communication with a retail shopping store or a plurality of retail shopping stores over a network and configured to send and receive data therefrom. Such communications may occur over one or more networks. Non-limiting examples of a communication module may be but not limited to: a communication module described in U.S. Pat. No. 5,307,463, issued to Hyatt et al.; or a communication module described in U.S. Pat. No. 6,133,886, issued to Fariello et al. which are incorporated for their supported herein.

The merchant module 20 includes a storage module 44 in communication with the administration module 40 and configured to store merchant and consumer data. The storage module 44 is configured to store retail item data associated with each and every item available for purchase at a retail shopping store associated with a virtual shopping cart module. The storage module 44 is configured to store merchant and consumer data that an administrator may access to analyze and assess purchasing data. Non-limiting examples of data storage modules may include databases and/or data files, and such may include hard drives and/or tapes and etc. Non-limiting examples of a storage module may be a portable data storage module as described in U.S. Pat. No. 7,802,729, issued to Thayer; or a data storage system described in U.S. Pat. No. 8,006,012, issued to Hou et al.; wherein these examples are incorporated for their supported teachings herein.

The merchant module 20 includes a query module 46 in communication with the storage module 44 and configured to query a consumer regarding a purchase or a non-purchase of a retail item at a retail shopping store. The query module 46 is also configured to enable an administrator to generate query questions to ask a consumer. The query module 46 is also configured to sort and query a central database having consumer and merchant data stored therein. Queries may be scheduled according to a script/schedule and/or may be selected by an intelligent system configured to optimize one or more of data collected, responses, useful responses, future purchases, and the like and combinations thereof. Factors that may be analyzed by such an intelligent system may include but are not limited to historical purchase data, demographic data of the account holder, current sales trend data, location data (like GPS data), future release data from manufacturers/providers, pricing data, inventory level data, and the like and combinations thereof. Non-limiting examples of a query module may be a query module as described in U.S. Pat. No. 7,039,634, issued to Xu et al.; or a query system as described in U.S. Patent Publication No.: 2005/0038777, by Anderson et al.; wherein these examples are incorporated for their supported teachings herein.

The merchant module 20 includes an incentive offer module 48 in communication with the query module 46 and configured to provide an incentive to a non-purchasing consumer. The incentive offer module 48 is configured to generate an incentive to a consumer for using a virtual shopping cart module at a retail shopping store. The consumer may have to complete a task at a retail shopping store to receive an incentive; or a consumer may scan a RFID tag of a retail item and not purchase the retail item; and then receive an incentive to purchase the retail item during a predetermined period of time. The incentive offer module 48 is configured to generate an incentive to a consumer, such as a discount or purchase incentive to a consumer to purchase a retail item at the retail shopping store. Incentives may be scheduled according to a script/schedule and/or may be selected by an intelligent system configured to optimize one or more of data collected, responses, useful responses, future purchases, and the like and combinations thereof. Factors that may be analyzed by such an intelligent system may include but are not limited to historical purchase data, demographic data of the account holder, current sales trend data, location data (like GPS data), future release data from manufacturers/providers, pricing data, inventory level data, and the like and combinations thereof. Non-limiting examples of a incentive offer module 48 may be a incentive delivery system as described in U.S. Patent Publication No.: 2010/0153198, by Murphy et al.; or an incentive method and system as described in U.S. Patent Publication No.: 2008/0196060, by Varghese; or an incentive system as described in U.S. Patent Publication No.: 2008/0172292, by Hurowitz et al.; wherein these examples are incorporated for their supported teachings herein.

The merchant module 20 includes a tracking module 50 in communication with the administration module 40 and configured to track global positioning data from a global positioning module of a virtual shopping cart module 10 of a personal communication device. The tracking module 50 is configured to track the movement of a consumer while shopping at a retail shopping store. The tracking module 50 is configured to track the time a consumer spends in a retail shopping store. The tracking module 50 is configured to track a the number of times a consumer visits a retail shopping store. The tracking module is in communication with the storage module 44 and configured to store consumer tracking data therein. Non-limiting examples of a tracking module may be a tracking module as described in U.S. Patent Publication No.: 2009/0072975, by Arguin; or a player tracking module system as described in U.S. Pat. No. 8,022,867, issued to Pomerantz et al.; or a tracking module as described in U.S. Pat. No. 5,912,980, issued to Hunke; wherein these examples are incorporated for their supported teachings herein.

The merchant module 20 includes an analysis module 52 in communication with the query module 46 and the storage module 44. The analysis module 52 is configured to analyze consumer data from a virtual shopping cart module and from a retail shopping store. The analysis module 52 is configured to sort, graph, analyze, organize, separate, group, etc. consumer data to be used by an administrator to generate a marketing strategy or a reward or incentive program for a retail shopping store. Non-limiting examples of a analysis module may be an analysis module as described in U.S. Patent Publication No.: 2008/0052248, by Jeng; or an analysis system as described in U.S. Pat. No. 6,134,304, issued to Norell; or an analysis system as described in U.S. Patent Publication No.: 2003/0083925, by Weaver et al.; wherein these examples are incorporated for their supported teachings herein.

The merchant module 20 includes a rewards generating module 54 in communication with the query module 46 and configured to provide a reward to a consumer for completing or answering a query or a set of queries. The reward may be a discount on a purchase of a retail item. The reward generating module 54 is configured to generate a reward to a consumer for purchasing a retail item of an abandoned virtual shopping cart. The reward generating module 54 is configured to generate a reward for performing activities within the retail shopping store, such as scanning a retail item, rating a retail item, reviewing a retail item, reviewing experience at the retail shopping store, etc. Rewards may be scheduled according to a script/schedule and/or may be selected by an intelligent system configured to optimize one or more of data collected, responses, useful responses, future purchases, and the like and combinations thereof. Factors that may be analyzed by such an intelligent system may include but are not limited to historical purchase data, demographic data of the account holder, current sales trend data, location data (like GPS data), future release data from manufacturers/providers, pricing data, inventory level data, and the like and combinations thereof. Non-limiting examples of a reward generating module 54 may be a reward system as described in U.S. Patent Publication No.: 2007/0078719, by Schmitt et al.; or a reward platform system as described in U.S. Patent Publication No.: 2004/0186770, by Pettit et al.8 or a reward system as described in U.S. Patent Publication No.: 2006/0287871, by Carrozzi et al.; wherein these examples are incorporated for their supported teachings.

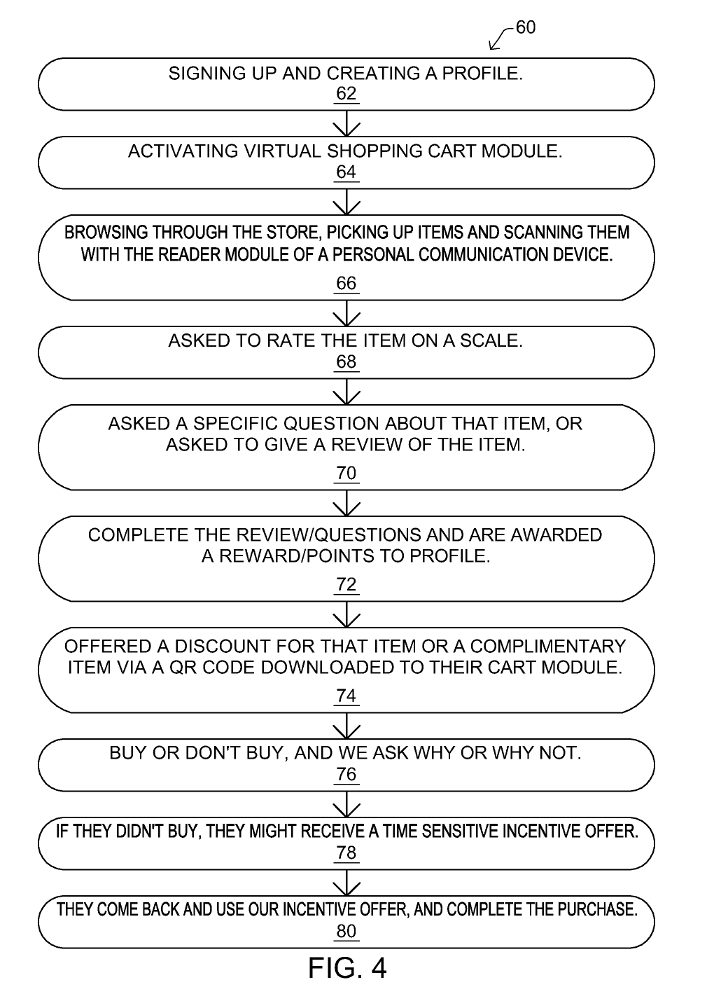

FIG. 4 illustrates a method of promoting a sale of retail goods, according to one embodiment of the invention. There is shown a method of promoting a sale of retail goods used by a consumer 60 at a retail shopping store. Such a method may use one or more of the modules described herein in the performance thereof. The

The illustrated method 60 includes the step of providing a virtual shopping cart module to a mobile device of a prospective consumer and having the consumer sign up and create a profile account 62. The consumer downloads the virtual shopping cart module over a network to a personal communication device. The consumer signs up for a profile account over a network or at the retail shopping store associated with the virtual shopping cart module.

The method 60 then includes activating the virtual shopping cart module when entering a retail shopping store associated therewith 64. The virtual shopping cart module is configured to automatically activate when in a vicinity of a retail shopping store associated with the virtual shopping cart module. The virtual shopping cart module may be configured to notify the consumer when in a vicinity of a retail shopping store associated with the virtual shopping cart module.

The method 60 includes reading identification data of a physical item of interest to the prospective consumer at a retail store through operation of a reader module of the virtual shopping cart module 66. The consumer scans a RFID tag of retail item in a retail shopping store and view data associated with the retail item and may purchase the retail item therefrom. The method 60 includes asking a consumer to rate a retail item 68.

The method 60 includes the step of querying the prospective consumer in regards to the physical item of interest 70. The step of querying the prospective consumer also includes storing an answer from the prospective consumer and associating the answer with the identification data of the physical item of interest; wherein the consumer receives a reward, such as points, to be used in purchasing retail items from the retail shopping store. The step of querying the consumer may include asking a specific question about a retail item, or asking the consumer to give a review of the retail item.

The method of promoting a sale of retail goods by a consumer 60 includes providing a reward to the prospective consumer. The step of providing a reward to the prospective customer includes awarding virtual points associated with a user profile of the prospective customer in response to receiving an answer 72. Upon completion of the review, the consumer is awarded a reward or points to be used at the retail shopping store 74. The reward or points are added to the consumer's profile and may be used at a later date. The reward or points may include an expiration date.

The method 60 includes instructions to ask the consumer if the consumer made a purchase or a retail item. The instructions include asking the consumer why or why not, or reasoning as to why or why not the consumer made a purchase of a retail item 76. If the consumer did not make a purchase of the retail item, the consumer receives an incentive to make the purchase 78. The incentive may be time sensitive. The incentive is saved in the consumer's profile. The consumer comes back at a later date, and uses the incentive offer to complete the purchase 80.

According to one embodiment of the invention, the method includes the step of providing a first purchase opportunity for the prospective customer to purchase the physical item of interest. The first purchase opportunity includes a purchase incentive. The method includes determining whether the prospective customer purchases the physical item of interest during the first purchase opportunity and providing a second purchase opportunity if the prospective customer did not purchase the physical item of interest during the first purchase opportunity. The second purchase opportunity may include an enhanced incentive to purchase the physical item of interest. The method may further include the step of communicating identification data of a physical item of interest to a server module over a network.

The method of promoting a sale of retail goods includes the step of querying the prospective customer as to a purchase decision associated with the first purchase opportunity. The method includes the step of communicating purchase decision information to a server module over a network. The method also includes automatically generating a purchase incentive based on user profile information. The method includes the step of automatically generating an enhanced purchase incentive based on purchase decision information. The method further includes the step of communicating an enhanced purchase incentive from a server module to a mobile device over a network.

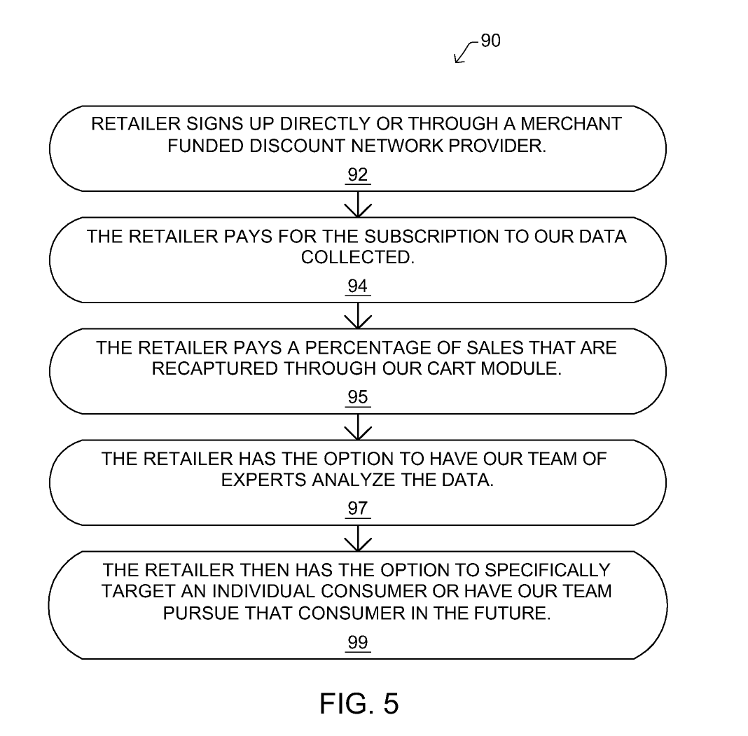

FIG. 5 illustrates a method of promoting a sale of retail goods, according to one embodiment of the invention. There is shown a method of promoting a sale of retail goods by a merchant at a retail shopping store 90. Such a method may use one or more of the modules described herein in the performance thereof.

The illustrated method of promoting a sale of retail goods by a merchant 90 includes the step of a retailer signing up directly or through a merchant funded discount network provider 92 to be associated with a virtual shopping cart system. The method 90 includes the step of the retailer paying for a subscription to the virtual shopping cart system, for the collection of consumer data by the virtual shopping cart module 94.

The method 90 includes the step of the retailer paying a percentage of sales that are recaptured through the virtual shopping cart module 95 to the virtual shopping cart system. The method 90 also includes the step of the retailer choosing an option to have experts from the virtual shopping cart system to analyze the consumer data collected from the virtual shopping cart modules 97. The method 90 further includes the step of the retailer choosing an option to specifically target an individual consumer or have the virtual shopping cart system pursue or contact the individual consumer in the future 99.

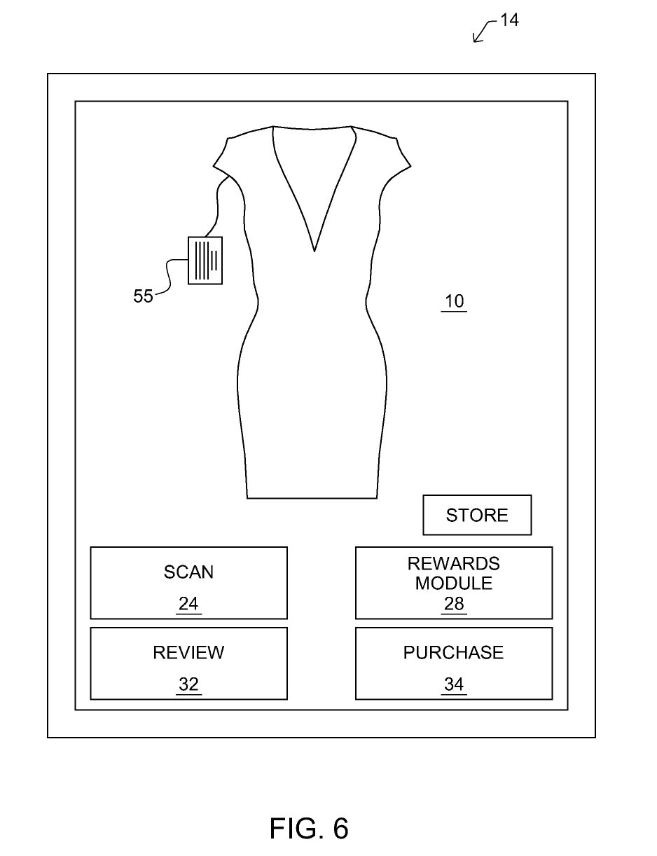

FIG. 6 illustrates a personal digital assistant including a virtual shopping cart module of a system of promoting a sale of retail goods, according to one embodiment of the invention. There is shown a personal digital assistant including a virtual shopping cart module having a reader module scanning a retail item.

In one non-limiting example, a consumer may perform one or more of the following: they sign up and create a profile/account with the system, and may immediately earn some points for future redemption; they activate a smartphone application as they enter a store (or otherwise are determined to be in the store, such as but not limited to through scanning an item and/or via geo-location/GPS); they browse the store, picking up items and scanning them with their smart phone; they are asked by the system through the smartphone application to rate that item on some sort of scale (1-10, 1-5, smiley faces, etc.); they are then asked a specific question about that item, or they are asked to review it; they complete the review/question and may be awarded points that they can redeem for Fun Money or etc.; should they choose to buy or not to buy, they may be offered a discount for that item or a complementary item via a QR code downloaded to their phone; they buy or don't buy, and the system asks about why or why not a purchase was made; if they don't buy, they may receive a time sensitive offer to come back and complete the transaction; they may come back and use an offer (e.x. QR code), and may complete the purchase, wherein the system tracks the success of the offer through its redemption.

In one non-limiting example, a retailer may perform one or more of the following: retailer signs up with the system directly or may do so indirectly such as but not limitd to through a Merchant Funded Discount Network provider; the retailer pays for a subscription to the system's data collected through surveys; such data may be tiered to provide information on par with the level of subscription; the retailer pays a percentage of sales that are recaptured through operation of the system; the retailer has the option to have a team of experts analyze the data, to have analysis be performed automatically by the system, or to have its own team perform an analysis; the retailer may have the option to specifically target an individual consumer directly outside of the system and/or indirectly through operation of the system.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the description speaks of a single retail store, it is understood that a great variety of retail stores not jointly owned may all be part of such a system and may operate independently and/or in a coordinated fashion in a single system or single set of systems as described herein, which systems may be different embodiments of the described invention.

Additionally, although the figures illustrate a particular order of steps and particular steps, it is understood that the exact protocols and steps used in such a system as that described herein are plethoric.

It is also envisioned that a retail store and/or a mobile device may include one or more of the modules described herein even if such a module was not illustrated and/or described as being included and/or includable within either the retail store and/or the mobile device and that non-described modules may be added to the invention as desired/needed.

It is expected that there could be numerous variations of the design of this invention. An example is that the user interfaces may be of an infinite variety of what is displayed and how it is displayed such that particular retail stores, manufacturers and the like may be able to effectively communicate their brands thereon.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of promoting a sale of retail goods, comprising the steps of:
a) providing a virtual shopping cart module to a personal communication device of a prospective customer;
b) reading identification data of a physical item of interest to the prospective customer at a retail store through operation of a reader module of the virtual shopping cart module;
c) querying the prospective customer in regards to the physical item of interest;
d) storing an answer from the prospective customer;
e) associating the answer with the identification data of the physical item of interest;
f) providing a reward to the prospective customer;
g) providing a first purchase opportunity for the prospective customer to purchase the physical item of interest;
h) determining whether the prospective customer purchases the physical item of interest during the first purchase opportunity; and
i) providing a second purchase opportunity if the prospective customer did not purchase the physical item of interest during the first purchase opportunity.

2. The method of claim 1, wherein the second purchase opportunity includes an enhanced incentive to purchase the physical item of interest.

3. The method of claim 1, further comprising the step of communicating identification data of a physical item of interest to a server module over a network.

4. The method of claim 1, wherein the first purchase opportunity includes a purchase incentive.

5. The method of claim 1, wherein the step of providing a reward to the prospective customer includes awarding virtual points associated with a user profile of the prospective customer in response to receiving an answer.

6. The method of claim 1, further comprising the step of querying the prospective customer as to a purchase decision associated with the first purchase opportunity.

7. The method of claim 1, further comprising the step of communicating purchase decision information to a server module over a network.

8. The method of claim 1, further comprising the step of automatically generating a purchase incentive based on user profile information.

9. The method of claim 1, further comprising the step of automatically generating an enhanced purchase incentive based on purchase decision information.

10. The method of claim 1, further comprising the step of communicating an enhanced purchase incentive from a server module to a mobile device over a network.

11. A system for promoting the sale of retail goods over a computerized network, comprising
a) a virtual shopping cart module operationally deliverable to a personal communication device over a network, including:
a1) a reader module configured to scan a physical tag of a retail item and including instructions for controlling a sensing device of a personal communications device configured to sense identifying information from a physical tag;
a2) a storage module in communication with the reader module and configured to store scanned data as a virtual shopping cart, wherein scanned items are queued for purchase;
a3) a purchase module in communication with the storage module and configured to facilitate purchase of items associated with the virtual shopping cart data and including instructions for assigning a characteristic of abandoned to a virtual shopping cart data set in response to failure to purchase a scanned item within a predetermined purchase characteristic, thereby forming an abandoned virtual shopping cart;
a4) a review module configured to query a consumer regarding an opportunity to purchase a retail item associated with virtual shopping cart data;
a5) an incentive module configured to provide incentives to a consumer for reviewing a retail item associated with virtual shopping cart data; and
a6) a rewards module configured to manage rewards and incentives of a consumer associated with the virtual shopping cart data and including instructions for providing a reward for purchasing an item of an abandoned virtual shopping cart.

12. The system of claim 11, further comprising a global positioning module configured to track consumer global positioning of a virtual shopping cart module; wherein the virtual shopping cart module is within a vicinity of a retail shopping store.

13. The system of claim 12, further comprising a merchant module in communication with the virtual shopping cart module over a network, including:
a) an administration module configured to provide operational instructions to manage the modules and components of the merchant module;
b) a communication module in communication with the administration module and configured to provide communication to the modules and components of the merchant module;
c) a storage module in communication with the administration module and configured to store merchant and consumer data; and
d) a query module in communication with the storage module and configured to configured to query a consumer regarding a purchase or non-purchase of a retail item.

14. The system of claim 13, further comprising an incentive offer module in communication with the query module and configured to provide an incentive to a non-purchasing consumer.

15. The system of claim 14, further comprising a reward generating module in communication with the query module and configured to provide a reward for a consumer completing a query.

16. The system of claim 15, further comprising a tracking module in communication with the administration module and configured to track global positioning data from the global positioning module of the consumer module.

17. The system of claim 15, further comprising an analysis module in communication with the query module and the storage module, and configured to analyze data from the consumer module.

18. A system for promoting the sale of retail goods over a computerized network on a personal digital assistant, comprising
a) a virtual shopping cart module operationally deliverable to a personal communication device over a network, including:
a1) a reader module configured to scan a physical tag of a retail item and including instructions for controlling a sensing device of a mobile communications device configured to sense identifying information from a physical tag;
a2) a storage module in communication with the reader module and configured to store scanned data as a virtual shopping cart, wherein scanned items are queued for purchase;
a3) a purchase module in communication with the storage module and configured to facilitate purchase of items associated with the virtual shopping cart data and including instructions for assigning a characteristic of abandoned to a virtual shopping cart data set in response to failure to purchase a scanned item within a predetermined purchase characteristic, thereby forming an abandoned virtual shopping cart;
a4) a review module configured to query a consumer regarding an opportunity to purchase a retail item associated with virtual shopping cart data;
a5) an incentive module configured to provide incentives to a consumer for reviewing a retail item associated with virtual shopping cart data;
a6) a rewards module configured to manage rewards and incentives of a consumer associated with the virtual shopping cart data and including instructions for providing a reward for purchasing an item of an abandoned virtual shopping cart; and
a7) a global positioning module in communication with the virtual shopping cart module and configured to track consumer global positioning of a virtual shopping cart module; wherein the virtual shopping cart module is within a vicinity of a retail shopping store.
